(19) United States
(12) Patent Application Publication
(10) Pub. No.: US 2014/0019854 A1
(43) Pub. Date: Jan. 16, 2014

(54) REVIEWER FEEDBACK FOR DOCUMENT DEVELOPMENT

(71) Applicants: Eugenie L. Alexander, Spokane, WA (US); Arthur J. Bariska, JR., Tucson, AZ (US); Matthew T. Cousens, Catskill, NY (US); Eileen S. Kovalchick, Tucson, AZ (US); Joel L. Masser, San Jose, CA (US); Kevin D. McKenzie, Poughkeepsie, NY (US); Eileen P. Tedesco, Sharon, CT (US)

(72) Inventors: Eugenie L. Alexander, Spokane, WA (US); Arthur J. Bariska, JR., Tucson, AZ (US); Matthew T. Cousens, Catskill, NY (US); Eileen S. Kovalchick, Tucson, AZ (US); Joel L. Masser, San Jose, CA (US); Kevin D. McKenzie, Poughkeepsie, NY (US); Eileen P. Tedesco, Sharon, CT (US)

(73) Assignee: INTERNATIONAL BUSINESS MACHINES CORPORATION, Armonk, NY (US)

(21) Appl. No.: 13/546,201

(22) Filed: Jul. 11, 2012

(51) Int. Cl. G06F 17/21

(52) U.S. Cl. 715/266

(57) ABSTRACT

A system, method and program product for receiving feedback about a document from one or more reviewers includes a step of a computer receives feedback about a document, responsive to input from the one or more reviewers into a user interface. The computer stores the feedback about the document. The computer transmits a notification to an owner of the document that the feedback has been received and stored. Responsive to receiving a request from the owner, the computer opens the document and displays the document with the feedback received. Responsive to input from the owner, the computer changes the document and saves a new version of the document.

### FIELD OF THE INVENTION

The present invention relates generally to document development and more specifically to receiving reviewer feedback on documents for a writer's review.

### BACKGROUND

Many forms of documents are developed by writers to facilitate communication to readers. The documents are often prepared using word processing and other similar programs with human readable formats. In many cases, during the development of the documents the writer(s) wish to receive feedback from readers. Face to face and teleconference meetings are effective ways to collect feedback, but are rather cumbersome and difficult to schedule.

Redundant reviewing and feedback reporting occurs when a document is put out for review to multiple reviewers at the same time. In many cases, more than one reviewer will find the same problem and provide feedback to the owner regarding the same issue. Redundant reviewing and feedback reporting may be both time-consuming and a substantial waste of resources.

In one specific example, valuable feedback from customers on technical documentation is cumbersome to provide, and as a result is often never submitted to the owner/writer of the publication. Currently, customers may provide feedback by reading a review copy of the document written and provided by the owner, and then selecting an option to enter details of a change and where in the document the changes should be made by the owner. The owner of the document must then analyze the feedback from the customer and determine how to incorporate the change within the normal (non-review) copy of the document.

### SUMMARY

Aspects of the present invention disclose a method, system and program product for receiving feedback about a document from one or more reviewers.

A system, method and program product for receiving feedback about a document from one or more reviewers includes a step of a computer receives feedback about a document, responsive to input from the one or more reviewers into a user interface. The computer stores the feedback about the document. The computer transmits a notification to an owner of the document that the feedback has been received and stored. Responsive to receiving a request from the owner, the computer opens the document and displays the document with the feedback received. Responsive to input from the owner, the computer changes the document and saves a new version of the document.

### BRIEF DESCRIPTION OF THE SEVERAL VIEWS OF THE DRAWINGS

FIG. 1 depicts a data processing system for reviewer feedback on documents according to an embodiment of the present invention.

FIG. 2 is a flow chart illustrating the steps of a program installed in a computer of FIG. 1 for receiving reviewer feedback.

FIG. 3 is a flow chart illustrating the steps of a program installed in a computer of FIG. 1 for accepting reviewer feedback.

FIG. 4 is a flow chart illustrating the steps of a program installed in a computer of FIG. 1 for determining and accepting changes related to changes already accepted within a document.

FIG. 5 depicts a block diagram of internal and external components of a data processing system in accordance with an illustrative embodiment.

### DETAILED DESCRIPTION

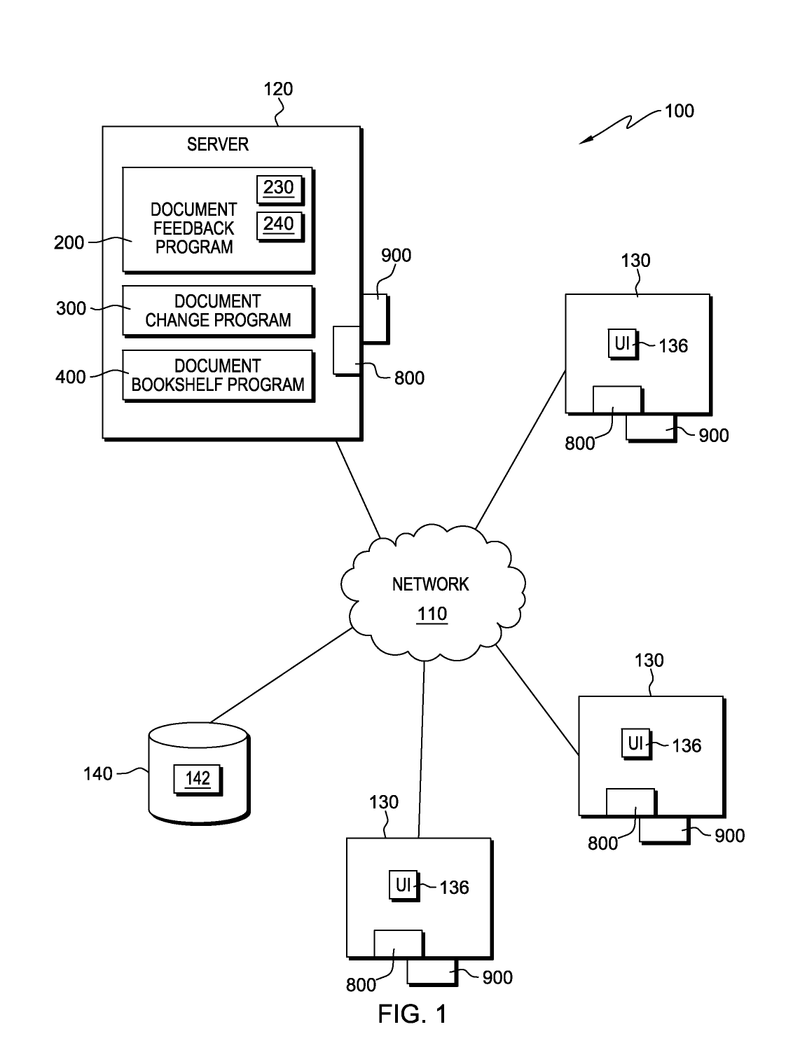

The present invention will now be described in detail with reference to the figures. FIG. 1 illustrates a data processing system, generally designated 100, according to one embodiment of the present invention.

Data processing system 100 includes a network 110, a server computer 120, multiple client computers, such as client computers 130, and a network storage device 140 containing a file repository 142. In the depicted example, network 110 is the Internet representing a worldwide collection of networks and gateways that use the Transmission Control Protocol/Internet Protocol (TCP/IP) suite of protocols to communicate with one another. In other examples, network 110 may also be implemented as a number of different types of networks, such as, but not limited to an intranet, a local area network (LAN), or a wide area network (WAN). Examples of network 110 include wire cables, wireless communication links, fiber optic cables, routers, switches, and/or firewalls. Server computer 120, client computers 130 and network storage device 140 are interconnected by network 110.

Server computer 120 may be, for example, a management server, a web server, or any other electronic device or computer system capable of receiving and sending data. In another embodiment, server computer 120 represents a “cloud” of computers interconnected by one or more networks, where server computer 120 is a primary server for a computer system utilizing clustered computers and components to act as a single pool of seamless resources when accessed through network 110. This is a common implementation for data centers in addition to cloud computing applications. Client computers 130 are clients to server computer 120 and may be, for example, a notebook computer, a laptop computer, a tablet computer, a handheld device or smart-phone, a thin client, or any other electronic device or computing system capable of communicating with server computer 120 through network 110.

Server computer 120 executes document feedback program 200 for receiving reviewer feedback. Document feedback program 200 includes a document retrieval program function 230 to retrieve a document, responsive to reviewer request, stored in file repository 142 and display the document on a user interface (UI) 136 of a client computer, such as 130. Document retrieval program function 230 flags the document as currently being updated, so that other reviewers and/or owners know that the document is being updated. In one example, document retrieval program function 230 displays on UI 136 a flag associated with the document to indicate that the document is currently being reviewed. The flag is checked when a reviewer and/or owner tries to access the document. The reviewer receives a message that the document is currently being updated and is not currently accessible. In another example, the flag associated with the document does not prevent other reviewers from accessing the document while the document is flagged. In this example, the flag indicates that the document is currently being updated and allows other readers to view the potential update even before it is accepted by the owner.

Document feedback program 200 also includes document review program function 240 to receive feedback and store feedback about the document from one or more reviewers. The document review program function 240 displays a user interface for the reviewer to input feedback that is related to the document. Many different forms of user interfaces may be used to receive different forms of feedback from the reviewer, such as, but not limited to: problems, questions, comments, etc. The reviewer inputs feedback through the user interface, and document review program function 240 highlights a section of the document related to each item of feedback inputted by the reviewer. In some examples, highlighting of the document sections may include change bars, colors, notes in the margin, etc. In an optional example, the reviewer may select an option in the user interface to indicate the type of feedback the reviewer is submitting. Document review program function 240 automatically retrieves the document information, such as the document version, section, page, paragraph, line, and other meta-data associated with the document, and stores the document information by associating the document information with the document.

Document review program function 240 determines whether or not communication preferences of a reviewer are known. In one example, the reviewers may register to use document feedback program 200. When the reviewers register, the reviewers provide an email address, with an identification and password that provides access to use document feedback program 200. Document feedback program 200 accesses the provided communication preferences from the profile of the reviewer to send the communications to the reviewer.

Different modes for how the reviewers prefer to receive the communications may be used. In one example, the reviewers register to receive the communications from server computer 120 by email. In other examples, the mode may be multimedia messaging service (MMS), short message service (SMS), instant messaging, videotelephony, or any other form of possible communication. The communication preferences may be stored in a storage device, such as a database, or other locations. In an example, the document review program function 240 determines whether or not the communication preferences of the reviewer are stored in the database or other storage device.

If the communication preferences of the reviewer are stored, document review program function 240 retrieves the communication preferences. If the communication preferences of the reviewer are not stored, document review program function 240 prompts the reviewer to provide the communication preferences through UI 136. Document review program function 240 receives the communication preferences after the reviewer inputs the communication preferences into UI 136. Document review program function 240 stores the feedback and the associated communication preferences of the reviewer in network storage device 140, so that the owner may access the feedback at a later time.

Server computer 120 executes document change program 300 for sending a notification to an owner of a document to consider if the owner accepts the feedback and/or the changes recommended by one or more reviewers. In this example, once the feedback and associated communication preferences have been stored, document change program 300 sends a notification through an electronic communication to the one or more owners associated with the document that the feedback that may include proposed changes. Different modes for how the one or more owners prefer to receive the communications may be used. In one example, the owners register to receive the communications from server computer 120 via email. In other examples, the mode may be multimedia messaging service (MMS), short message service (SMS), instant messaging, videotelephony, or any other form of possible communication. The communication preferences may be stored in a storage device, such as a database, or other location.

Document change program 300 receives a request to open the document, responsive to an input of the owner into UI 136. Document change program 300 locks the document within the database to prevent access to the document by other owners and/or reviewers, along with displaying the document and associated feedback provided by the one or more reviewers on UI 136 so the owner may review the feedback. In some examples, depending upon the security classification of the document, an option may be included to allow the reviewers to view the feedback provided by the different reviewers when the document is locked. If the owner agrees with the suggestions, comments, etc. provide in the feedback, the owner may initiate a request to change the document through UI 136. Document change program 300 receives the request to change the document, and document change program 300 changes the document utilizing the input from reviewer and/or owner, depending upon the type of feedback provided by the reviewer. In one example, in the instance where the reviewer provides alternative language for a portion of the document, upon the request of owner to change the document, document change program 300 automatically replaces alternative language in the document from the highlighted language included in the feedback.

In another example, the owner may need to alter the feedback suggested by the reviewer. The owner updates the proposed change in the feedback and document change program 300 automatically replaces the content in the document with the updated changed content. Or, if the multiple updates are submitted for a same section of the document, the owner can select all the proposed updates and create a final update selecting and editing the parts from some or all of the proposed changes. In another example, the reviewer submits the feedback in the form of a question/comment that does not require an update to the document. The owner adds a response included in a response to the reviewer by document change program 300. Depending on the security level of the document, the response may or may not be viewable by the other reviewers and/or owners.

If the owner requests one or more changes to the document, document change program 300 creates a delta or another form of discrete file associated with the document. The delta may include the updated content, such as text, along with the section, paragraph, and line where the change is to be inserted within the document. However, in some examples, upon the request of the owner, document change program 300 may not create a delta, but rather, document change program 300 saves a new version of the document when the owner requests one or more changes to the document. After document change program 300 saves the new version of the document or the related delta, document change program 300 unlocks access to the new version of the document or the document with the related delta so that the owners and/or the reviewers may provide additional feedback and view the document. Document change program 300 notifies the reviewer of any changes made to the document by utilizing the communication preferences supplied by the reviewer. Document change program 300 may notify the reviewer of only the changes that relate to the feedback supplied by the reviewer, or may notify the reviewer of any changes made to the document.

Server computer 120 executes document bookshelf program 400 for determining and accepting changes related to the changes already accepted by the owner within the document. Document bookshelf program 400 displays a repository of similar text that may also be updated, sometimes referred to as a bookshelf, on UI 136. The display of the repository of similar text on UI 136 may be user-initiated, or may be automatically displayed when the owner and/or the reviewer opens the document for review and/or to provide the feedback. In one example, the repository of the similar text automatically displays when the owner opens the document to review the feedback. In another example, the repository of the similar text automatically displays to the reviewer after the reviewer provides the feedback on the document. In these examples, document bookshelf program 400 receives a request for a repository of similar text, responsive to the user input.

After receiving a request for a repository of similar text, document bookshelf program 400 determines the data in the document related to the feedback provided by the reviewer and displays the data in UI 136. In one example, document bookshelf program 400 displays a first portion of the data related to the feedback provided by the reviewer. The owner has the option to change the first portion of the data related to the feedback provided by the reviewer. If the owner decides to change the document, the owner may input the changes into the document using UI 136 utilizing the feedback provided by the reviewer. In some examples, document bookshelf program 400 automatically replaces text or other portions of the document with the recommended data, upon receiving the input from the owner through UI 136. However, in other examples, the owner inputs changes into UI 136 and document bookshelf program 400 implements changes to the document. Document bookshelf program 400 prompts the owner for each instance of where the owner may want to include additional changes to the document related to the feedback provided by the reviewer. The owner decides whether or not each change should be made to the document until a decision is made on all of the suggested changes determined by document bookshelf program 400.

File repository 142 is a central data location where the feedback and/or the documents may be managed by document feedback program 200, document change program 300, and/or document bookshelf program 400 on server computer 120. File repository 142 is stored in network storage device 140, which can be local or remote to server computer 120. Some examples of management tools provided by document feedback program 200, document change program 300, and/or document bookshelf program 400 include a document editor, work-item tracking, version control (also referred to as source control or revision control), and build management. Such tools are included in previously known collaboration software. Users of client computers 130 may access and edit documents in file repository 142 as allowed by document feedback program 200, document change program 300, and/or document bookshelf program 400. In other embodiments, the documents and/or the feedback may be stored, in addition to or alternative to being stored in file repository 142, on separate computer systems, such as client computers 130. In one embodiment, the document is a technical journal developed collaboratively by a number of people.

Client computers 130 include respective user interfaces (UIs) 136 for interfacing with document feedback program 200, document change program 300, and/or document bookshelf program 400. UIs 136 may be web-based UIs through which the users interact via a web-browser on either an attached or externally connected client computer.

Server computer 120 and client computers 130, each include respective internal components 800, and respective external components 900, as described in more detail below.

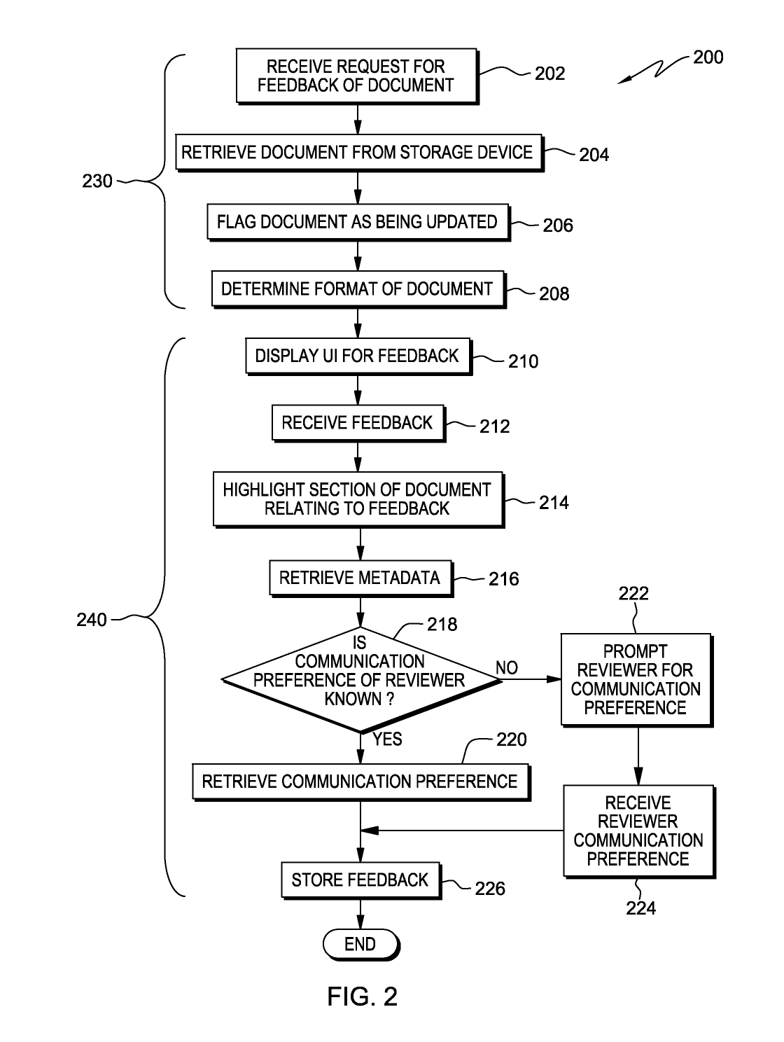

FIG. 2 is a flowchart illustrating the steps of document feedback program 200 for receiving feedback from one or more reviewers.

In step 202, document feedback program 200 receives a request for feedback on a document. In one example, document feedback program 200 receives the request for the feedback on the document through UI 136 of client computer 130, responsive to a selection of a reviewer. In other examples, access to provide the feedback may be implemented in various ways, e.g. right clicking to select the option, or selecting an option to provide the feedback from a tab. Furthermore, existing voice recognition software could be used to allow the reviewer to say “put me in feedback mode”, or other similar techniques.

In step 204, document feedback program 200 retrieves the document from a storage device 140, such as file repository 142. In one example, document feedback program 200 retrieves the current version of the document that contains all the markups from the previous changes, whether or not the feedback on the changes/comments is available to the reviewer. In step 206, document feedback program 200 flags the document stored in storage device 140 as currently being updated. Here, document feedback program 200 has the capability of using a number of flagging criteria. In step 208, document feedback program 200 determines a format of the document that is viewable by the reviewer on client computer 130.

Collectively, steps 202, 204, 206, and 208 may be performed by document retrieval program function 230 within document feedback program 200.

In step 210, document feedback program 200 displays UI 136 on client computer 130, which allows the reviewer to input the feedback within UI 136 regarding comments, suggestions, corrections, etc. In step 212, document feedback program 200 receives the feedback, responsive to an input from the reviewer into UI 136 on client computer 130. In step 214, document feedback program 200 highlights at least a portion of the document relating to the feedback received by document feedback program 200, responsive to the input from the reviewer. In step 216, document feedback program 200 retrieves metadata related to the document that is utilized by the document feedback program during the review process.

Document feedback program 200 determines if the communication preferences of the reviewer are known (decision block 218). In one example, the communication preferences of the reviewer(s) are stored in a storage device associated with a user account, such as an employee profile account, etc. If document feedback program 200 determines that the communication preferences of the reviewer are known (positive branch of decision 218), document feedback program 200 retrieves the communication preferences of the reviewer (step 220). If the document feedback program 200 has not determined the communication preferences of the reviewer (negative branch of decision 218), document feedback program 200 prompts the reviewer for the communication preferences through UI 136 (step 222). In step 224, document feedback program 200 receives the communication preferences of the reviewer, responsive to the input of the reviewer into UI 136. In step 226, document feedback program 200 stores the feedback related to the document, and associated the feedback related to the document with the metadata and the communication preferences of the reviewer.

Collectively, steps 210, 212, 214, 216, 218, 220, 222, 224, and 226 may be performed by document review program function 240 within document feedback program 200.

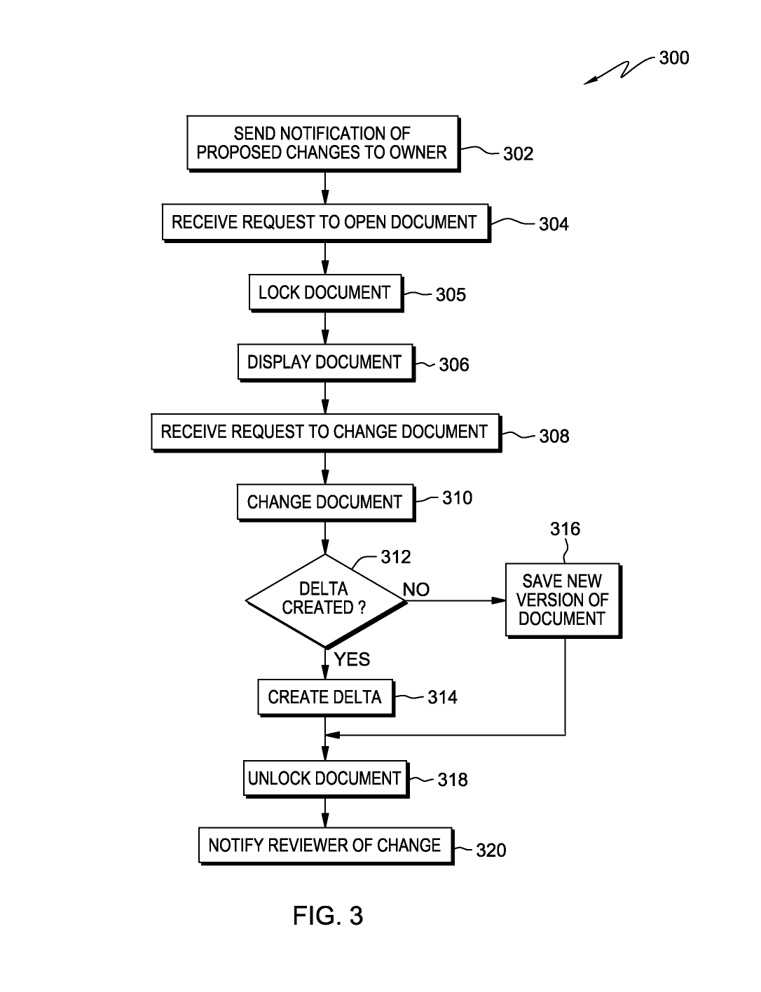

FIG. 3 is a flowchart illustrating the steps of document change program 300 for sending a notification to an owner of document to consider if the owner accepts the feedback and/or the changes recommended by the one or more reviewers.

In step 302, document change program 300 transmits a notification to the owner of the document that feedback has been received. In step 304, document change program 300 receives a request to open the document stored in file repository 142 from the owner into UI 136 on client computer 130. In step 305, document change program 300 locks access to additional reviewers and/or owners to the document stored in file repository 142. In step 306, document change program 300 displays the document with the related feedback on UI 136. In step 308, document change program 300 receives a request to change the document using the feedback and/or the metadata that is stored that relates to the document.

In step 310, document change program 300 changes the document utilizing the feedback and/or the metadata that is stored. Document change program 300 determines if a delta should be created, based on preferences that are stored and relate to the document (decision block 312). If document feedback program 300 determines that the delta should be created (positive branch of 312), document feedback program 300 creates and stores the delta by associating the delta with the document (step 314). If document feedback program 300 determines that the delta should not be created (negative branch of 312), document feedback program 300 saves and stores a new version of the document (step 316). In step 318, document feedback program 300 unlocks access for additional reviewers and/or owners to the document stored in file repository 142. In step 320, document feedback program 300 notifies the reviewer if a change is accepted or is not accepted by the owner.

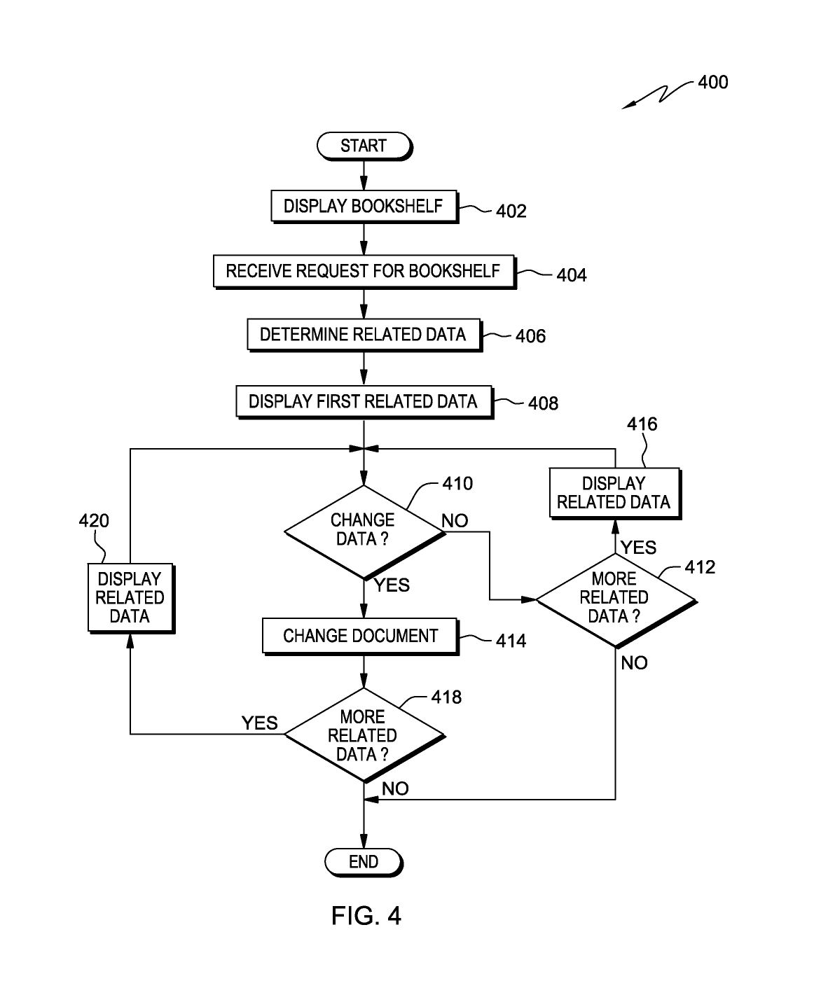

FIG. 4 is a flowchart illustrating the steps of document bookshelf program 400 for determining and accepting changes related to the changes already accepted by the owner within the document.

In step 402, document bookshelf program 400 displays the bookshelf on UI 136. In some examples, the bookshelf is automatically displayed. However, in other examples, the bookshelf is displayed responsive to a user input into UI 136. In step 404, document bookshelf program 400 receives a request for bookshelving the document, responsive to an input from the owner into UI 136. Bookshelving a document is when data related to the feedback provided by a reviewer for a section of the document is compared against other sections of the document where the feedback provided by the reviewer is useful. The steps of bookshelving a document are incorporated within the document bookshelf program, as described hereafter.

In step 406, document bookshelf program 400 determines if there is data in the document that is related to the feedback from the reviewer. Using existing search methods, document bookshelf program 400 searches for content that is similar in the document than content contained in the bookshelf. In some examples, the owner has an option of indicating that if text that is exactly the same as already changed text is found, the exact text will be automatically updated. In another example, the owner may select to be notified first to approve the update. If text is similar but not exact, the owner may be notified to approve the update.

In step 408, document bookshelf program 400 displays on UI 136 first data in document related to the feedback from the reviewer. The owner of the document may have previously specified how to be notified that the feedback is available, similar to the methods previously described of notifying the reviewer. In some examples, the notification includes a link to the feedback provided by the reviewer, which the owner will open and the feedback is displayed on UI 136.

Document bookshelf program 400 modifies the first data in the document related to the feedback from the reviewer, responsive to an input from the owner into UI 136 if the owner determines modifications are desirable (decision block 410). If document bookshelf program 400 receives the input from the owner into UI 136 to not make modifications to the document (negative branch of decision 410), document bookshelf program 400 determines if there is additional data in the document related to the feedback from the reviewer that the owner may want to modify (decision block 412). If document bookshelf program 400 receives the input from the owner into UI 136 to make modifications to the document (positive branch of decision 410), document bookshelf program 400 modifies the document (step 414).

If document bookshelf program 400 determines that there is additional data in the document related to the feedback from the reviewer that the owner may want to modify (positive branch of decision 412), document bookshelf program displays on UI 136 more data in the document related to the feedback from the reviewer (step 416), then document bookshelf program 400 loops back to decision block 410.

Document bookshelf program 400 determines if there is additional data in the document related to the feedback from the reviewer that the owner may want to modify (decision block 418).

If document bookshelf program 400 determines that there is additional data in the document related to the feedback from the reviewer that the owner may want to modify (positive branch of decision 418), document bookshelf program displays on UI 136 more data in the document related to the feedback from the reviewer (step 420), then document bookshelf program 400 loops back to decision block 410.

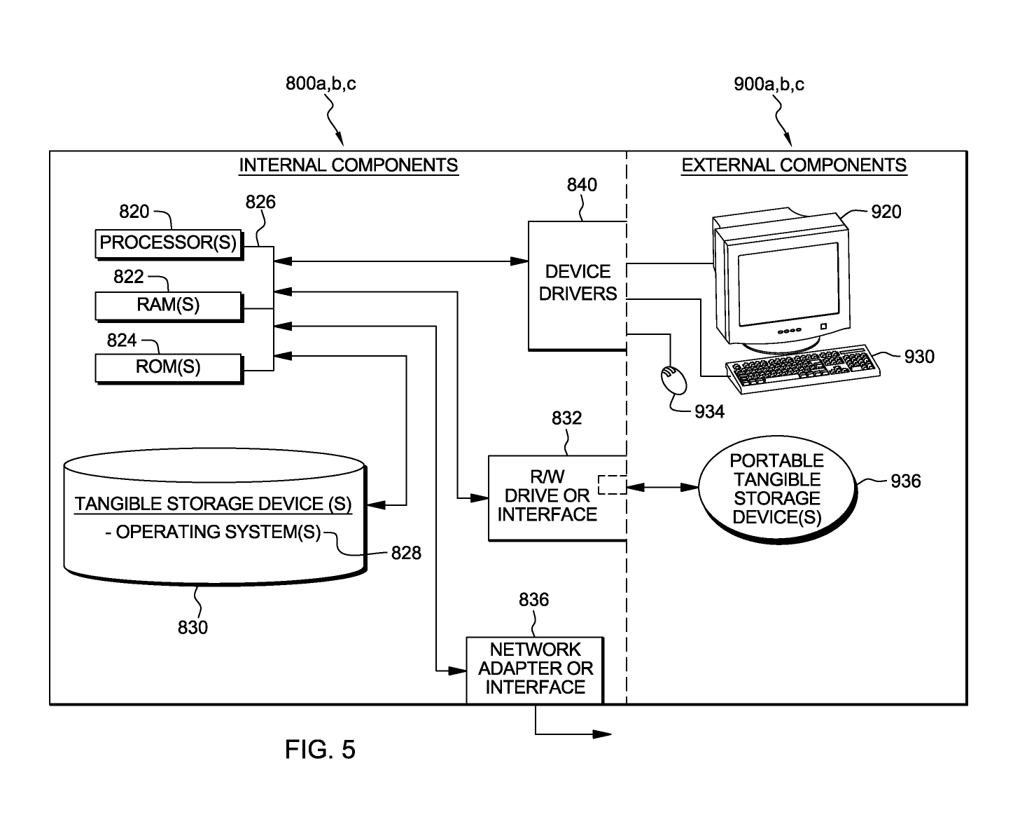

Computers 120 and 130 include respective sets of internal components 800a, b, c and external components 900a, b, c, illustrated in FIG. 5. Each of the sets of internal components 800a, b, c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and programs 200, 300, and 400 (for computer 120) are stored on one or more of the respective computer-readable tangible storage devices 830 for execution by one or more of the respective processors 820 via one or more of the respective RAMs 822 (which typically include cache memory). In the illustrated embodiment, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, b, c also includes a R/W drive or interface 832 to read from and write to one or more portable computer-readable tangible storage devices 936 such as a CD-ROM, DVD, memory stick, magnetic tape, magnetic disk, optical disk or semiconductor storage device. The programs 200, 300, and 400 (for computer 120) can be stored on one or more of the respective portable computer-readable tangible storage devices 936, read via the respective R/W drive or interface 832 and loaded into the respective hard drive 830.

Each set of internal components 800a, b, c also includes a network adapter or interface 836 such as a TCP/IP adapter card. The programs 200, 300, and 400 (for computer 120) can be downloaded to the respective computers from an external computer or external storage device via a network (for example, the Internet, a local area network or other, wide area network) and network adapter or interface 836. From the network adapter or interface 836, the programs are loaded into the respective hard drive 830. The network may comprise copper wires, optical fibers, wireless transmission, routers, firewalls, switches, gateway computers and/or edge servers.

Each of the sets of external components 900a, b, c includes a computer display monitor 920, a keyboard 930, and a computer mouse 934. Each of the sets of internal components 800a, b, c also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The programs can be written in various programming languages (such as Java®, C++) including low-level, high-level, object-oriented or non object-oriented languages. Alternatively, the functions of the programs can be implemented in whole or in part by computer circuits and other hardware (not shown).

Based on the foregoing, a computer system, method and program product have been disclosed for allocating and reallocating primary and secondary destinations. However, numerous modifications and substitutions can be made without deviating from the scope of the present invention. Therefore, the present invention has been disclosed by way of example and not limitation.

What is claimed is:

1. A method for receiving feedback about a document from one or more reviewers, the method comprising:
a computer receiving feedback about a document, responsive to input from the one or more reviewers into a user interface;
the computer storing the feedback about the document;
the computer transmitting a notification to an owner of the document that the feedback has been received and stored;
responsive to receiving a request from the owner, the computer opening the document and displaying the document with the feedback received; and
responsive to input from the owner, the computer changing the document and saving a new version of the document.

2. The method of claim 1, further comprising:
the computer locking access to the document for one or more additional reviewers; and
the computer unlocking access to the document for the one or more additional reviewers.

3. The method of claim 1, further comprising:
the computer flagging the document as currently being updated.

4. The method of claim 1, further comprising:
the computer highlighting at least a portion of the document relating to the feedback received.

5. The method of claim 1, further comprising:
the computer retrieving the document from storage responsive to a request from the one or more reviewers for feedback about the document; and
the computer determining a format of the document that is viewed by the one or more reviewers and displaying the document on a user interface that allows the one or more reviewers to input feedback within the user interface.

6. The method of claim 1, further comprising:
the computer determining if communication preferences of the one or more reviewers are known;
responsive to determining that the communication preferences of the one or more reviewers are known, the computer retrieving the communication preferences of the one or more reviewers.

7. The method of claim 6, further comprising:
responsive to determining that communication preferences of the one or more reviewers are not known, the computer prompting the one or more reviewers for the communication preferences through the user interface; and
responsive to input of the one or more reviewers into the user interface, the computer receiving the communication preferences of the one or more reviewers and storing the communication preferences of the one or more reviewers.

8. The method of claim 1, further comprising:
the computer notifying the one or more reviewers if the feedback is accepted or is not accepted by the owner.

9. The method of claim 1, further comprising:
the computer receiving a request to bookshelf the document, responsive to input from the owner into the user interface; and
the computer determines data in the document related to the feedback provided from the one or more reviewers.

10. The method of claim 9, further comprising:
the computer displaying on the user interface first data in the document related to the feedback provided from the one or more reviewers; and
the computer modifying the first data in the document related to the feedback provided from the one or more reviewers.

11. A computer system comprising one or more processors, one or more computer-readable memories, one or more computer-readable, tangible storage devices and program instructions which are stored on the one or more storage devices for execution by the one or more processors via the one or more memories and when executed by the one or more processors implement all the steps of claim 1.

12. A computer program product for receiving feedback about a document from one or more reviewers, the computer program product comprising:
one or more computer-readable, tangible storage devices;
program instructions, stored on at least one of the one or more storage devices, to receive feedback about a document, responsive to input from the one or more reviewers into a user interface;
program instructions, stored on at least one of the one or more storage devices, to store the feedback about the document;
program instructions, stored on at least one of the one or more storage devices, to transmit a notification to an owner of the document that the feedback has been received and stored;
program instructions, stored on at least one of the one or more storage devices, responsive to receiving a request from the owner, to open the document and display the document with the feedback received; and
program instructions, stored on at least one of the one or more storage devices, responsive to input from the owner, to change the document and save a new version of the document.

13. The computer program product of claim 12, further comprising:
program instructions, stored on at least one of the one or more storage devices, to lock access to the document for one or more additional reviewers; and
program instructions, stored on at least one of the one or more storage devices, to unlock access to the document for the one or more additional reviewers.

14. The computer program product of claim 12, further comprising program instructions, stored on at least one of the one or more storage devices, to highlight at least a portion of the document relating to the feedback received.

15. The computer program product of claim 12, further comprising program instructions, stored on at least one of the one or more storage devices, to flag the document stored in the storage device as currently being updated.

16. The computer program product of claim 12, further comprising:
program instructions, stored on at least one of the one or more storage devices, to retrieve the document from storage responsive to a request from the one or more reviewers for feedback about the document; and
program instructions, stored on at least one of the one or more storage devices, to determine a format of the document that is viewed by the one or more reviewers and display the document on a user interface that allows the one or more reviewers to input feedback within the user interface.

17. The computer program product of claim 12, further comprising:
program instructions, stored on at least one of the one or more storage devices, to determine if communication preferences of the one or more reviewers are known;
program instructions, stored on at least one of the one or more storage devices, responsive to input of the one or more reviewers into the user interface, responsive to determining that the communication preferences of the one or more reviewers are known, to retrieve the communication preferences of the one or more reviewers.

18. The computer program product of claim 17, further comprising:
program instructions, stored on at least one of the one or more storage devices, responsive to determining that communication preferences of the one or more reviewers are not known, to prompt the one or more reviewers for the communication preferences through the user interface; and
program instructions, stored on at least one of the one or more storage devices, responsive to input of the one or more reviewers into the user interface, to receive the communication preferences of the one or more reviewers and store the communication preferences of the one or more reviewers.

19. The computer program product of claim 12, further comprising:
program instructions, stored on at least one of the one or more storage devices, to notify the one or more reviewers if the feedback is accepted or is not accepted by the owner.

20. The computer program product of claim 12, further comprising:
program instructions, stored on at least one of the one or more storage devices, to receive a request to bookshelf the document, responsive to input from the owner into the user interface; and
program instructions, stored on at least one of the one or more storage devices, to determine data in the document related to the feedback provided from the one or more reviewers.

21. The computer program product of claim 20, further comprising:
program instructions, stored on at least one of the one or more storage devices, to display on the user interface first data in the document related to the feedback provided from the one or more reviewers; and
program instructions, stored on at least one of the one or more storage devices, to modify the first data in the document related to the feedback provided from the one or more reviewers.
